(19) United States
(12) Patent Application Publication
(10) Pub. No.: US 2005/0017140 A1
(43) Pub. Date: Jan. 27, 2005

(54) Mounting board and method of making same

(76) Inventor: Jeffrey F. King, North Port, FL (US)

Correspondence Address: MCDONALD HOPKINS CO., LPA, 2100 BANK ONE CENTER, 600 SUPERIOR AVENUE, E., CLEVELAND, OH, 44114-2653, US

(21) Appl. No.: 10/867,173

(22) Filed: Jun. 14, 2004

Related U.S. Application Data
(60) Provisional application No. 60/478,223, filed on Jun. 13, 2003.

(51) Int. Cl. F16M 11/00

(52) U.S. Cl. 248/200

(57) ABSTRACT

When numerous objects must be mounted in a confined area, a mounting board can be used to support the objects in an orderly manner. Current mounting board designs are time consuming and labor intensive to use, require numerous tools to use, and may damage the surface on to which it mounts. The present mount board design and method of manufacturing comprises a sheet member having a longitudinal axis, and a plurality of raised members integrally formed from the sheet member for receiving connection devices, wherein the raised members are configured on the sheet member to mount the longitudinal members to the mounting board in both parallel and perpendicular directions relative to the longitudinal axis by using the connection devices.

### CROSS-REFERENCE TO RELATED APPLICATIONS

This application claims priority from U.S. Provisional Patent Application No. 60/478,223 filed on Jun. 13, 2003, which is hereby incorporated by reference herein.

### FIELD OF INVENTION

The present invention relates to mounting boards, and more particularly, to mounting boards and a method of efficient manufacture wherein the mounting board has integral raised members for receiving connection devices for mounting longitudinal members thereto.

### BACKGROUND

Numerous methods for mounting objects to support surfaces are known in the art for a variety of applications. When numerous objects, however, must be mounted in a confined area, a mounting board can be used to support the objects in an orderly manner. Dependent upon the mounting requirements, such mounting boards typically comprise a solid surface for receiving a mounting member connected by a screw, clip, clamp, or adhesive. Depending upon the surface to which the objects are to be supported, the mounting member may be connected directly thereto.

One area that requires the maintenance of numerous objects in an organized and orderly fashion is the wiring harness industry, specifically described herein with reference to the marine industry. Boats have numerous wires, hoses, and lines that must be maintained in an orderly fashion or risk tangling or damage thereto. Further, added components must include an orderly and efficient method of mounting and maintaining the wiring in a well-supported and out-of-the-way position.

Wire chassis for mounting wiring and other components are made from a variety of materials and generally attach to a surface, e.g., the interior of a boat hull. Such wire chassis are generally mechanically fastened directly to the support surface and either captures the wire between the chassis and the hull surface or include an aperture for receiving a cable tie. Other types of wire chassis are mounted by adhesive patch to a hull surface for clamping the wire therebetween. Enclosed in FIG. 7 is a catalog page showing some of the currently available cable tie holders.

There are numerous disadvantages in using the wire chassis and cable tie holders presently known. With the use of individual cable tie holders, installation is often time consuming and labor intensive when mounting several wires and components. Further, the installer must use numerous tools such as a drill, a screwdriver, or wrench to mount the cable tie holders to the hull surface. Also, mounting the holder directly on the hull surface by mechanical fastening means damages the hull surface and can present numerous structural as well as aesthetic issues. Further, metal mounting arrangements are exposed to moisture and heat to encourage rusting and corrosion, further affecting the structural and aesthetic integrity of the mounting arrangement. Finally, given the need to use many individual mounting components, the resultant mounting arrangement may be haphazard and unattractive when completed.

It is an object of the present invention to make wire and hose system installation easier. It is also an object of the present invention to provide a mounting board that is far less labor intensive to use than the present known products. It is also an object of the present invention to improve the quality and appearance of the wiring and hose system installation.

### SUMMARY OF THE INVENTION

In accordance with the present invention there is provided a mounting board for mounting at least one longitudinal member thereto, the mounting board comprising a sheet member having a longitudinal axis, and a plurality of raised members integrally formed from the sheet member for receiving connection devices, wherein the raised members are configured on the sheet member to mount the longitudinal members to the mounting board in both parallel and perpendicular directions relative to the longitudinal axis by using the connection devices.

In accordance with the present invention there is further provided a method of manufacturing a mounting board for mounting longitudinal members thereto, the method comprising providing a sheet member having a longitudinal axis, and forming a plurality of raised members from the sheet member for receiving connection devices, the raised members being integral with the sheet member and being configured on the sheet member parallel and perpendicular to the longitudinal axis of the sheet member to mount the longitudinal members in both parallel and perpendicular directions relative to the longitudinal axis using the connection devices.

The present invention will be more fully described in the following written description with reference to the accompanying drawings.

### DESCRIPTION OF THE DRAWINGS

Objects and advantages together with the operation of the invention may be better understood by reference to the following detailed description taken in connection with the following illustrations, wherein:

FIG. 1 is a view of a first embodiment of the present invention;

FIG. 2 is a view of FIG. 1 where longitudinal members are mounted on the mounting board with connection devices;

FIG. 3 is a top view of the first embodiment of FIG. 1 along lines X-X;

FIG. 4 is a second embodiment of the present invention;

FIG. 5 a view of FIG. 4 where longitudinal members are mounted on the mounting board with connection devices;

FIG. 6 is a third embodiment of the present invention;

FIG. 7 a view of FIG. 6 where longitudinal members are mounted on the mounting board with connection devices.

### DETAILED DESCRIPTION OF THE INVENTION

As shown in the accompanying drawings, wherein like characters represent the same or corresponding parts throughout the several views, the mounting board, generally designated as 5, comprises a sheet member 10 having a longitudinal axis 12 and a backside 14. The mounting board 5 further includes a plurality of raised members 15 capable of receiving connection devices 20 so as to mount at least one longitudinal member 25, such as a wire, hose, line, cable, strand, chain, tubes, or such thereto.

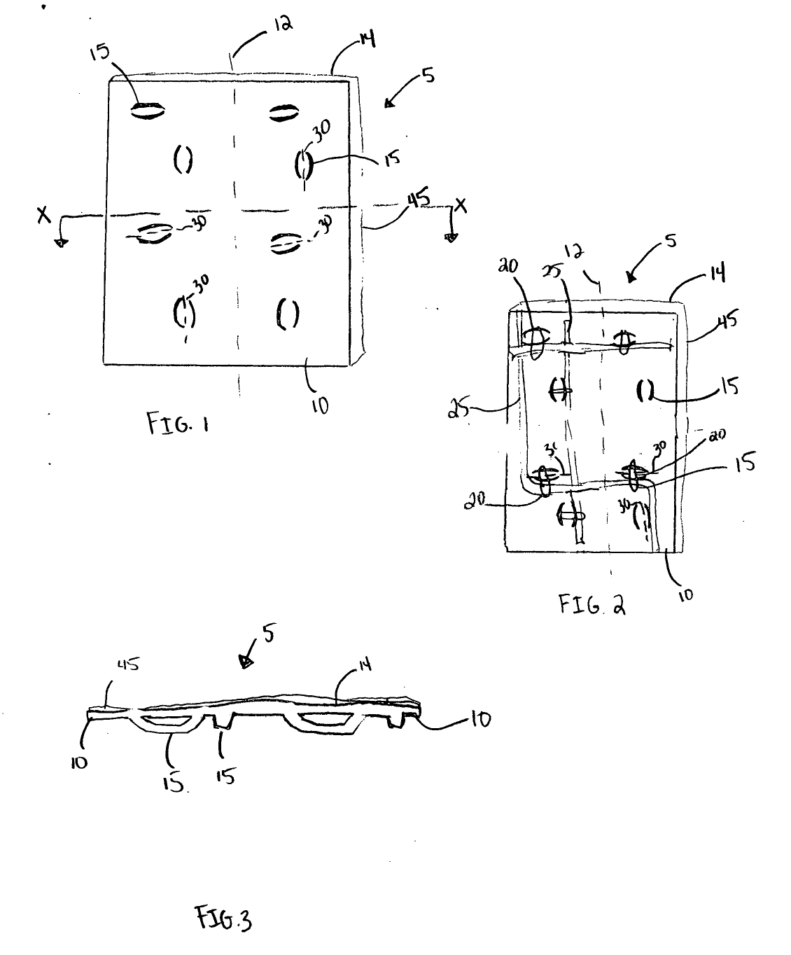

The sheet member 10 of the mounting board 5 may be made out of a variety of materials such as steel, aluminum, or other suitable material. The sheet member 10, however, is preferably manufactured from plastic. As most appropriate for the marine industry, a plastic sheet member 10 is relatively inexpensive to manufacture, corrosion resistant, low weight, flexible, and easy to cut to specific configurations. The sheet member 10 may be a plastic sheet that is pigmented white and has UV stabilizers added to the polymer. The standard sheet size is 5/32″ thick by 48″ wide and 96″ long. The sheet member 10, however, is not limited to the shape, size, or color referred to above. It may be of a variety of shapes, sizes, and colors. For example, if a hull of a boat is gray, the sheet member 10 may be colored gray to blend with the hull. Further, the sheet member 10 can be configured to a particular shape and size as needed to neatly and efficiently fit within a confined space. Finally, the sheet member 10 is not limited to being substantially flat as depicted in FIGS. 1 through 6. The sheet member 10 can also be curved, sloped, angled, etc., to match the configuration of any surface onto which it is attached.

As best seen in FIG. 3, the raised members 15 of the mounting board 5 are integrally formed from the sheet member 10 and can be formed as raised loops. It should be understood, however, that the raised members 15 can be formed as other shapes, not just raised loops. The raised members 15 include longitudinal axes 30 and are configured on the sheet member 10 to mount the longitudinal members 25 to the mounting board 5 in both parallel and perpendicular directions relative to the longitudinal axis 12 of the sheet member 10 by using the connection devices 20, such as wire ties, plastic wire ties, nylon wire ties, or such. As shown in FIG. 2, the mounting board 5 of the first embodiment utilizes columns of raised members 15 in alternating vertical and horizontal orientations. More particularly, the longitudinal axes 30 of a first portion of the raised members 15 are parallel to the longitudinal axis 12 of the sheet member 10. And, the longitudinal axes 30 of a second portion of the raised members 15 are perpendicular to the longitudinal axis 12 of the sheet member 10. Such an alternating configuration provides a mounting arrangement that permits mounting of longitudinal members 25 in an orderly and efficient manner.

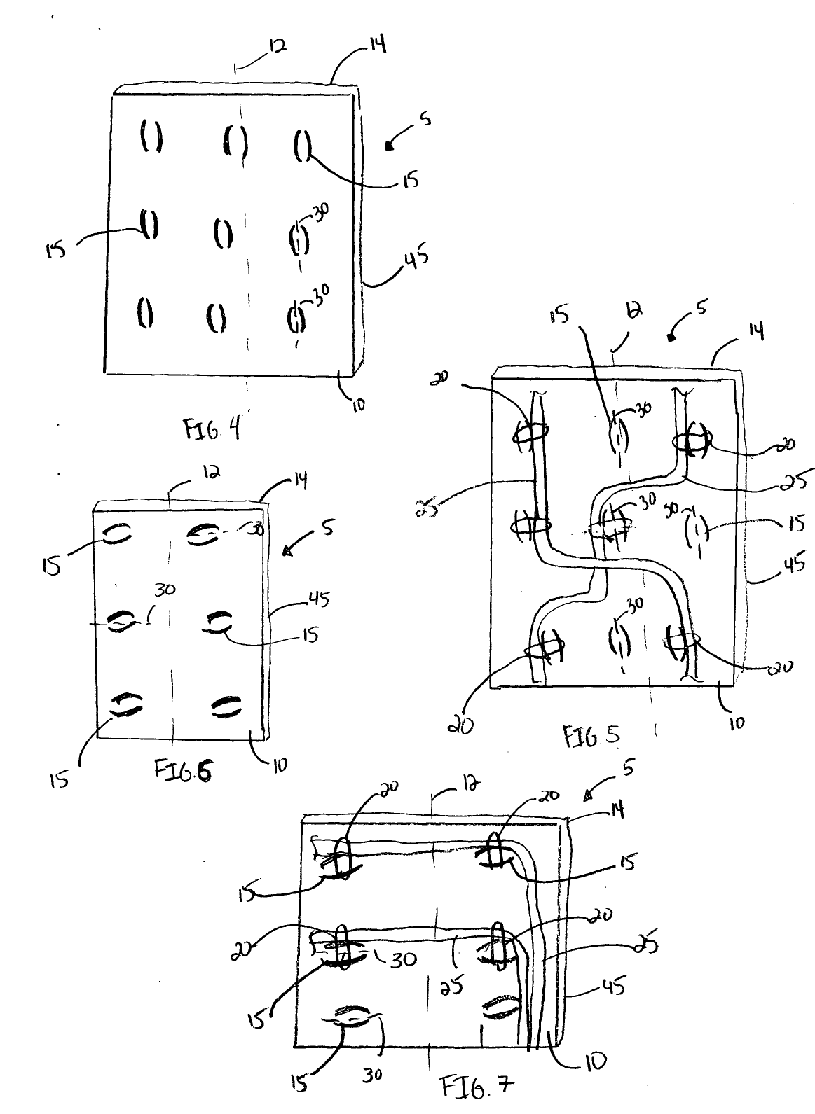

In an alternate embodiment depicted in FIGS. 4 and 5, all of the raised members 15 are configured parallel to the longitudinal axis 12 of the sheet member 10. This configuration also allows the longitudinal members 25 to be mounted to the mounting board 5 in both parallel and perpendicular directions relative to the longitudinal axis 12 of the sheet member 10. In another alternative embodiment depicted in FIGS. 6 and 7, the raised members 15 are configured perpendicular to the longitudinal axis 12 of the sheet member 10. This configuration also allows the longitudinal members 25 to be mounted to the mounting board 5 in both parallel and perpendicular directions relative to the longitudinal axis 12 of the sheet member 10.

Using the raised members 15 on the mounting board 5 allows one person to install the longitudinal members 25 using the connection devices 20 and no further tools as shown in FIGS. 2, 5, and 7. A particular advantage with the present invention is that the mounting board 5 may be sold as pre-loop punched, sheets. These sheets, therefore, can be cut to fill irregular areas for a neater looking installation having a custom fit.

The mounting board 5 may be mounted to a support surface by any means necessary. While the mounting board 5 can be mounted to the support surface by mechanical fasteners, the mounting board 5 preferably is mounted by use of adhesives. Preferably, the mounting board 5 is provided with an adhesive layer 45 on the backside 14 so that the mounting board 5 can be mounted to the support surface without damaging the support surface. Having such an adhesive layer 45 also makes installation quicker and easier. Typical nylon wires ties with an adhesive patch can lose adhesion and can eventually fail. With the mounting board 5, the adhesive layer 45 has a much greater area and can be of a much stronger type creating a bond that will not fail.

Application of the mounting board 5 to the support surface by adhesion is particularly useful in the boating industry. Putting screws into boat hulls has been a source of many problems over the years, such as leaks, rotting of core materials due to water penetration, and the need for backing materials to be added to the fiberglass lay-up to accept the screw. Bonding the mounting board 5 with an adhesive to hull surface or to a soft plastic surface avoids these problems. Also, since the mounting board 5 may be easily bonded to the surface, additional problems and added labor costs caused by using mechanical fasteners can be avoided.

The mounting board 5 may be manufactured any number of ways. One method of manufacturing the mounting board 5 is by forming the raised members 15 in the sheet member 10 by punching the sheet member 10 with a punch press to create the integral raised members 15 on the other side thereof. First, a die is created that will provide the resultant raised members 15 shape and dimensions. The sheet member 10 will then be moved within the punch press to punch the raised members 15 out in the required configuration. In one embodiment, the sheet member 10 is die punched with a configuration wherein the raised members 15 are parallel and perpendicular to the longitudinal axis 12 of the sheet member 10 to form raised members 15 in the sheet member 10 that will accept the connection devices 20 to mount the longitudinal members 25 in both parallel and perpendicular directions relative to the longitudinal axis 12 of the sheet member 10. Alternatively, the sheet member 10 can be die punched with a configuration wherein the raised members 15 are parallel to the longitudinal axis of the sheet member 10 to form raised members 15 in the sheet member 10 that will accept the connection devices 20 to mount the longitudinal members 25 in both parallel and perpendicular directions relative to the longitudinal axis 12 of the sheet member 10. Finally, the sheet member 10 can be die punched with a configuration wherein the raised members are perpendicular to the longitudinal axis of the sheet member 10 to form raised members 15 in the sheet member 10 that will accept the connection devices 20 to mount the longitudinal members 25 in both parallel and perpendicular directions relative to the longitudinal axis 12 of the sheet member 10.

The present invention, therefore, has numerous advantages over the art. The present mounting board 5 is more attractive looking and more durable than most metal or PVC wire chassis. The mounting board 5 does not require the operator to carry multiple tools to mount the mounting board 5 or mount the longitudinal members 25. Also, the integral raised members 15 permit a much easier attachment and layout for straight or curved neat runs of the longitudinal members 25 using a the connection devices 20. This invention is clearly applicable to numerous industries other than the boating industry where the advantages of a mounting board are required.

The invention has been described above and, obviously, modifications and alternations will occur to others upon a reading and understanding of this specification. In addition, the method of assembly described above is not limited to the order in which the steps above are recited. The claims as follows are intended to include all modifications and alterations insofar as they come within the scope of the claims or the equivalents thereof.

1. A mounting board for mounting at least one longitudinal member thereto, the mounting board comprising:
a sheet member having a longitudinal axis; and
a plurality of raised members integrally formed from the sheet member for receiving connection devices, wherein the raised members are configured on the sheet member to mount the longitudinal members to the mounting board in both parallel and perpendicular directions relative to the longitudinal axis by using the connection devices.

2. The mounting board of claim 1, wherein the sheet member comprises a corrosion resistant material.

3. The mounting board of claim 2, wherein corrosion resistant material comprises plastic.

4. The mounting board of claim 3, wherein the sheet member further comprises a backside having an adhesive layer thereon, wherein the adhesive layer adheres the mounting board to a support surface of a marine vehicle.

5. The mounting board of claim 1, wherein the raised members comprise raised loops.

6. The mounting board of claim 5, wherein the raised loops comprise longitudinal axes, the raised loops being positioned on the mounting board with the longitudinal axes of the raised loops parallel to the longitudinal axis of the sheet member.

7. The mounting board of claim 5, wherein the raised loops comprise longitudinal axes, the raised loops being positioned on the mounting board with the longitudinal axes of the raised loops perpendicular to the longitudinal axis of the sheet member.

8. The mounting board of claim 5, wherein the raised loops comprise longitudinal axes, a first portion of the raised loops being positioned on the mounting board so the longitudinal axes of the first portion of the raised loops are parallel to the longitudinal axis of the sheet member and the longitudinal axes of a second portion of the raised loops being positioned perpendicular to the longitudinal axis of the sheet member.

9. The mounting board of claim 3, wherein at least a portion of the sheet member is curved.

10. A mounting board for mounting longitudinal members thereto, the mounting board comprising:
a sheet member having a longitudinal axis; and
a plurality of raised members integrally formed from the sheet member for receiving connection devices, wherein the raised members are configured on the sheet member in both parallel and perpendicular directions relative to the longitudinal axis of the sheet member to mount the longitudinal members in both parallel and perpendicular directions to the longitudinal axis using the connection devices.

11. The mounting board of claim 10, wherein the sheet member further comprises a backside having an adhesive layer thereon, wherein the adhesive layer adheres the mounting board to a support surface of a marine vehicle.

12. The mounting board of claim 10, wherein the raised members comprise raised loops.

13. The mounting board of claim 12, wherein the connection devices comprise wire ties that mount the longitudinal member to the mounting board by being inserted through the raised loops and around the longitudinal member.

14. A method of manufacturing a mounting board for mounting longitudinal members thereto, the method comprising:
providing a sheet member having a longitudinal axis; and
forming a plurality of raised members from the sheet member for receiving connection devices, the raised members being integral with the sheet member and being configured on the sheet member to mount the longitudinal members in both parallel and perpendicular directions relative to the longitudinal axis using the connection devices.

15. The method of claim 14, wherein forming the plurality of raised member comprises punching raised loops into the sheet member in a predetermined configuration.

16. The method of claim 15, wherein the raised loops further comprise longitudinal axes, the raised loops being punched into the sheet member with the longitudinal axes of the raised loops both parallel and perpendicular to the longitudinal axis of the sheet member.

17. The method of claim 15, wherein the raised loops further comprise longitudinal axes, the raised loops being punched into the sheet member with the longitudinal axes of the raised loops parallel to the longitudinal axis of the sheet member.

18. The method of claim 15, wherein the raised loops further comprise longitudinal axes, the raised loops being punched into the sheet member with the longitudinal axes of the raised loops perpendicular to the longitudinal axis of the sheet member.
